(19) United States
(12) Patent Application Publication
(10) Pub. No.: US 2021/0281007 A1
(43) Pub. Date: Sep. 9, 2021

(54) A COAXIAL CONNECTION SYSTEM INTENTED TO BE USED IN OUTDOOR ENVIRONMENTS

(71) Applicant: RADIAL, Aubervilliers (FR)

(72) Inventor: Shan QIN, Shanghai (CN)

(21) Appl. No.: 16/347,720

(22) PCT Filed: May 31, 2018
(86) PCT No.: PCT/CN2018/089366

§ 371 Date: May 6, 2019

(51) Int. Cl. H01R 13/52; H01R 13/622; H01R 13/512

(52) U.S. Cl. CPC H01R 13/5205; H01R 13/512; H01R 13/622; H01R 13/5202

(57) ABSTRACT

A coaxial connection system including a first system element forming a plug and a second system element forming a socket, each including a central contact and a peripheral body. The connection system includes a locking cap/nut, mounted free at least in translation around the plug or the jack, between an unlocking position and a locking position, and two annular sealing members of elastomeric material resistant to corrosion, one being arranged around the plug and the other around the jack and each being distant from the connection interface between the plug and the jack. The locking cap/nut is at least on its external surface in a corrosion-resistant material. The arrangement of the locking cap/nut and of the two annular sealing members is such that the locking cap/nut achieves in its locking position a radial compression to the inside the two annular sealing members defining a waterproof cavity.

### FIELD OF THE INVENTION

The present invention relates to a coaxial connection system, intended in particular to transmit radio frequency RF signals.

The applications particularly targeted by the invention are the connection of telecommunication equipment such as base transceiver stations BTS and RRU/RRH (remote radio unit/remote radio head) units for the wireless communications market.

The invention also relates generally to the connection systems in the medical domain, the industrial domain, the aeronautical or transport domain and the space domain.

The invention more particularly aims to propose a connection system of coaxial type for which the electrical and mechanical RF performance levels are controlled and stable over time, particularly when used in an outdoor environment, even in extreme temperature and/or humidity conditions.

### BACKGROUND OF THE INVENTION

Connection systems are now widely used in outdoor environments. To ensure a robust outdoor performance under severe conditions, the connection system itself often incorporates certain designs to adapt to and fulfil a variety of outdoor environmental requirements.

Among them, the sealing rating according to the IP68 standard is one of the most important given the liquid infiltration has a significant negative impact on the stability and safety of working electrical equipment. In the light of this, the protection against liquid leakage or dust cannot be ignored.

In order to achieve the IP68 rating, the companies Radiall, Rosenberger and Huber & Suhner have proposed a conventional solution that includes a dedicated rubber boot on the outside of the connection system to meet the waterproof requirement outside the connection interface.

Such a solution is shown on FIGS. 1 and 1A for a coaxial RF connection system 1 extending along a longitudinal axis X.

The system 1 comprises a plug 2 on which a coaxial cable 3 is mounted and a jack 4 also called socket. The plug 2 and the jack 4 are locked by a locking nut/cap 5 in their mutual connecting configuration and a rubber boot 6 covers the exterior of the plug 2, the locking cap 5 and the jack 4 from the cable 3.

More precisely, the plug 2 comprises a central contact 20 and a peripheral body 21 arranged at the periphery of the central contact 20. Inside the peripheral body 21, a ground contact 22 is arranged. The ground contact 22 is constituted by two parts, one part 22a being in in the form of an elongated body and the other part 22b, being in the form of a slotted sleeve arranged directly at the free end of the plug 2. Furthermore, an insulating body 23 is interposed between the central contact 20 and the peripheral body 21 and the ground contact 22.

The coaxial cable 3 mounted on the rear part of the plug 2 comprises a central conductor 30 and a metallic braid 31 between which an insulator 33 is interposed. An exterior insulating sheath 32 extended by an insulating sleeve 34 constitutes the peripheral part of the coaxial cable 3.

The jack 4 comprises a central contact 40 and a peripheral body 41 arranged at the periphery of the central contact. Said peripheral body 41 forms directly a ground contact. Eventually, a specific ground contact can be arranged of the peripheral body 41 to form the ground contact. Furthermore, an insulating body 43 is interposed between the central contact and the ground contact. In order to mechanically lock the mutual connection between the plug 2 and the jack 4, a locking cap 5 is provided, to be screwed around both the plug and the jack or to be clipped around them.

Once the locking has been achieved by the connecting cap 5, the rubber boot 6 is pushed from the rear part of the plug 2, around the coaxial cable 3 to cover the peripheral portion of both the plug 2, the jack 4 and the locking cap 5.

It can be seen also on FIG. 1A that an O-ring seal 7 is arranged at the interface between the ground contacts 22, 41.

DE202014002319U utility patent application, discloses a solution of the analogous prior art, which consists of an elastomeric boot, mounted around a coaxial cable and which comes to relate around the connectors once their connection is established.

WO2016/188692 patent application also discloses a sealing solution for external use with a flexible boot pushed around the plug connector which is connected to the base, the boot being provided at its free end with a sealing lip.

All these solutions based on an elastomeric (rubber) boot which is used to cover at least the two complimentary connectors once their mutual connection has been achieved have several drawbacks.

First, the installation of the elastomeric boot is not easy. Indeed, the rubber boot must be pre-installed on the cable, before the soldering process between the contacts of the cable and the ones of the plug and can only be mounted on said connector afterwards. It is extremely difficult or even impossible to install the sealing elastomeric boot directly on the finished cable assembly.

Moreover, the elastomeric boot is cumbersome. Thus, the rubber boot might expand when it is mounted on the connection system, which then in turn increases the radial size of the finished product, making notably the miniature connectors no longer miniature.

Besides, the elastomeric boot is expensive because it has a rather large volume thus consumes a large measure of material, and its demolding process is somewhat difficult, making its final unit price relatively high.

At last, while mating the male and the female connectors, the elastomeric boot may incur damage by abrasion if used improperly. And, it is quite difficult to replace the broken boot with a new one for the reason given above, i.e. the pre-installation on the cable.

There is therefore a need to find an alternative sealing design to eliminate the drawbacks above.

The invention aims to address all or part of these needs.

### SUMMARY OF THE INVENTION

Thus, the subject of the invention, according to one of its aspects, is a coaxial connection system, intended to be used in an outdoor environment, comprising:
a first system element forming a plug and a second system element forming a jack, the plug and the jack each comprising:
   a central contact,
   a peripheral body, arranged on the periphery of the central contact, forming a ground contact,
a locking cap or nut, mounted free at least in translation around the plug or the jack, between an unlocking position, in which the plug and jack are not locked and a locking position, in which it locks mechanically the plug and the socket in their mutual connecting configuration;
two annular sealing members of elastomeric material resistant to corrosion, one being arranged around the peripheral body of the plug and the other around the peripheral body of the jack, each being distant from the connection interface between the plug and the jack;

wherein said connecting cap/nut is at least on its external surface in a corrosion-resistant material; and

wherein the arrangement of said connecting cap/nut and of said two annular sealing members is such that the connecting cap/nut achieves in its locking position a radial compression to the inside the two annular sealing members defining with them a waterproof cavity (C).

According to an advantageous embodiment, the sealing members are elastic O-ring seals.

According to an advantageous variant, each sealing member is arranged in a groove of the periphery of the peripheral body.

Preferably, the inner diameter of each of the sealing members is smaller than the bottom diameter of the groove while its outer diameter is greater than the inner diameter of the locking cap.

According to a first variant, the locking cap ensures the locking by an internal portion being screwed onto a peripheral portion of the peripheral of the jack.

According to a second variant, the locking cap ensures the locking by clipping means clipped onto the peripheral body of the jack.

Preferably, the locking cap has a peripheral chamfer at least at one of its free ends which diameter is larger than the outer diameter of the annular sealing members.

Advantageously, the locking cap is made of a very low or null electrical conductivity material or is coated with a coated with galvanic anti-corrosion coating or is made in an amorphous metal.

In other words, the invention consists essentially to protect the locking mechanism against outdoor aggressions, i.e. penetration of elements (water, dust) inside the locking mechanism, as well as corrosion, more specifically galvanic corrosion, with a combination:
an inside protection of the locking mechanism by an enclosed space by two elastic sealing elements along with the locking cap, and a male connector and a female connector, when these connectors are mated with each other;
an outside protection of the locking mechanism by a locking cap/nut which external surface is in corrosion-resistant material, in order to guarantee the durability of this sealing solution with the enclosed space C, even in outdoor environments with extreme conditions of humidity and/or temperature.

The solution according to the invention allows to meet the sealing requirements of the screw-on connector outside its interface so that the connectors pair itself can achieve IP68 rating in mated condition without the help of any external accessories, without decreasing the feeling of a correct mating.

The solution according to the invention has the following main advantages:
the IP68 rating is achieved through the mutual cooperation of the elastic seals, the locking cap bodies of the connectors pair itself, so that the use of external accessories, such as a rubber/elastomeric boot according to the prior art, is avoided;
the size of the final product is not impacted by the sealing solution,
the service life is prolonged compared to the rubber/elastomeric boot according to the prior art,
the cost of the product is low,
the type of locking/unlocking cap (screwed or quick-lock by clipping) can be determined visually immediately, contrarily to the elastomeric boot according to the prior art: indeed, when said boot covers the connection system, it is difficult not to say impossible to know if the locking of the connection is a screw or a quick lock type.
no additional process steps are required, compared to an elastomeric sleeve which implies mandatory additional steps of pulling/pushing, especially with threaded locking, and,
at the same time the users are free from the cumbersome installation of the rubber/elastomeric boot according to the prior art.

### BRIEF DESCRIPTION OF THE DRAWINGS

The invention will be able to be better understood on reading the following description of exemplary and nonlimiting implementations thereof, and on studying the appended figures in which:

FIG. 1 is a side view partially in section of a coaxial connection system with an elastomeric sealing boot according to the prior art,

FIG. 1A is a longitudinal cross-sectional view of the connection system of FIG. 1, showing the relative arrangement of the elastomeric boot with regard to the other components of the connection system;

FIGS. 2 and 2A are cross-sectional views of an exemplary plug of a coaxial connection system according to a first embodiment of the invention, before and after the mounting of the locking cap/nut;

FIG. 3 is a cross-sectional view of an exemplary jack of a coaxial connection system according to a first embodiment of the invention, before the mutual connection with the plug of FIGS. 2 and 2A;

FIG. 4 is a cross-sectional view of the coaxial system according to the first embodiment of the invention, the plug and the jack being mutually connected and locked together by the locking cap which is screwed on the jack;

FIG. 5 is a cross-sectional view of an exemplary plug of a coaxial connection system according to a second embodiment of the invention, the locking cap/nut being already mounted around the plug;

FIG. 6 is a cross-sectional view of the coaxial power system according to the second embodiment of the invention, the plug and the jack being mutually connected and locked together by the locking cap, of the quick-lock type, which is clipped onto the jack.

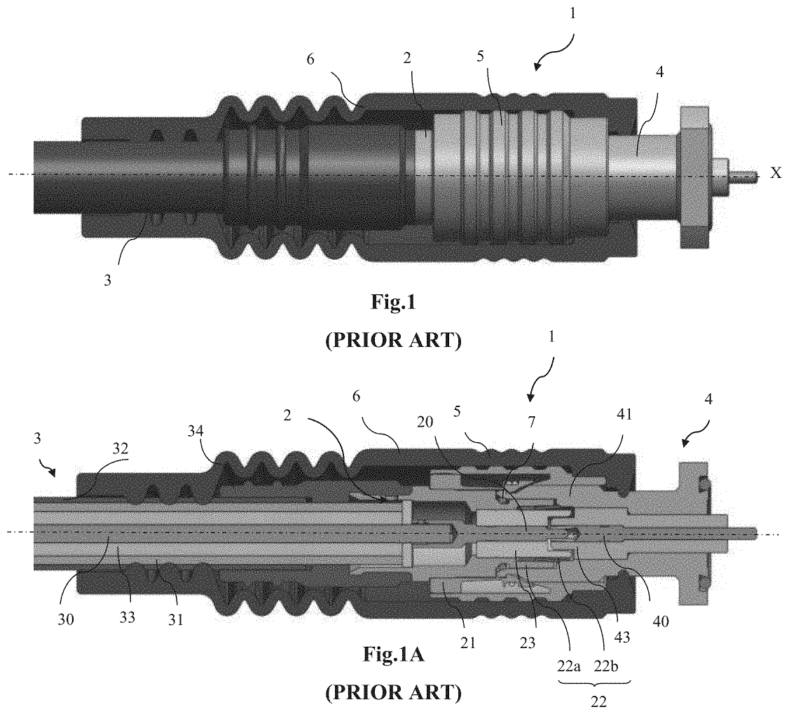

FIGS. 1 and 1A relate to an example of a coaxial connection system with an elastomeric sealing boot according to the prior art.

These FIGS. 1 and 1A have already been commented on in the preamble and will not therefore be commented on further herein below.

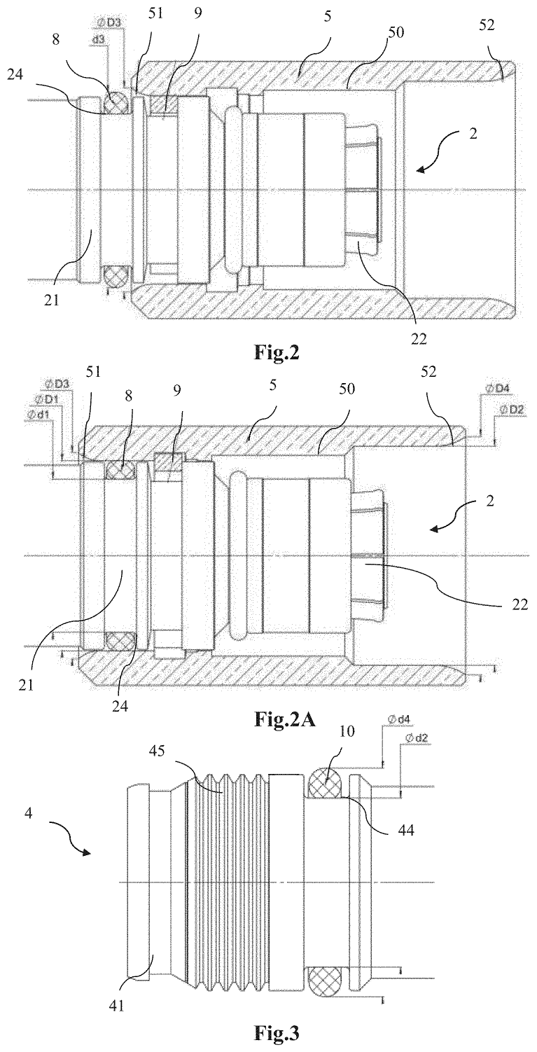

For clarity purposes, the same references designating the same elements of a connection system according to the prior art and of a connection system according to the invention are used for all the FIGS. 1 to 6.

Hereinafter, the invention is described with reference to any type of coaxial connection system.

In a coaxial connection system 1 according to the invention, each of the plug 2 and the jack 4 may comprise a solid insulating interposed between the central contact 20, 40 and the peripheral body 21, 41 and the ground contact 22.

The plug 2 comprises a central contact 20 and a peripheral body 21 arranged at the periphery of the central contact20. Inside the peripheral body 21, a ground contact 22 is arranged. The ground contact 22 is constituted by two parts, one part 22a being in in the form of an elongated body and the other part 22b, being in the form of a slotted sleeve arranged directly at the free end of the plug 2.

An insulating body 23 is arranged between the central contact 20 and the peripheral body 21 and ground contact 22.

A peripheral groove 24 is provided at the back of the peripheral body 21.

The locking cap/nut 5 has an internal portion 50 which is threaded and an internal chamfer 51, 52 at each of its free ends.

The locking cap/nut 5 is at least on its external surface in a corrosion-resistant material. It can be in a very low or null conductivity material or coated with galvanic anti-corrosion coating, such as aluminum anodization, paint, or even a plastic over-molding. Advantageously, the locking cap 5 is made in an amorphous metal such as a metal glass.

A first annular sealing member 8 of elastomeric material resistant to corrosion, which is an elastic O-ring seal in this example, is fitted in the groove 24 between the peripheral body 21 and the locking cap/nut 5. The outer diameter of the O-ring seal 8 is larger than the inner diameter D1 of the locking cap 5, and the inner diameter of the O-ring seal 8 is smaller than the bottom diameter d1 of the groove 24 so that the O-ring seal 8 fills the gap between the body 21 and the locking cap/nut 5 when it is assembled with the plug 2.

The chamfer 51 of the locking cap 5 has a diameter D3 that is larger than the outer diameter d3 of the O-ring seal 8 to ensure that this latter will not be damaged during assembly process between the cap 5 and the plug 2.

A retaining ring 9 ensures the longitudinal blocking of the locking cap/nut 5 around the plug 2, once assembled.

The jack 4 has a peripheral body forming a ground contact 41 which has a peripheral groove 44 provided at its back and a threaded external portion 45.

A second annular sealing member 10 of elastomeric material resistant to corrosion, which is an elastic O-ring seal in this example, is fitted in the groove 44. The inner diameter of the second O-ring seal 10 is smaller than the bottom diameter d2 of the ground contact 41 such that said second sealing member 10 is pre-stretched, to ensure that it cannot easily come out. The outer diameter d4 of the second O-ring seal 10 is smaller than the diameter D4 of the locking cap/nut 5.

Besides, the chamfer 52 of the locking cap 5 has a diameter D4 that is larger than the outer diameter d4 of the second O-ring seal 10 to ensure that said second seal 10 will not be damaged while coupling the plug 2 and the jack 4 and the locking by screwing the cap 5.

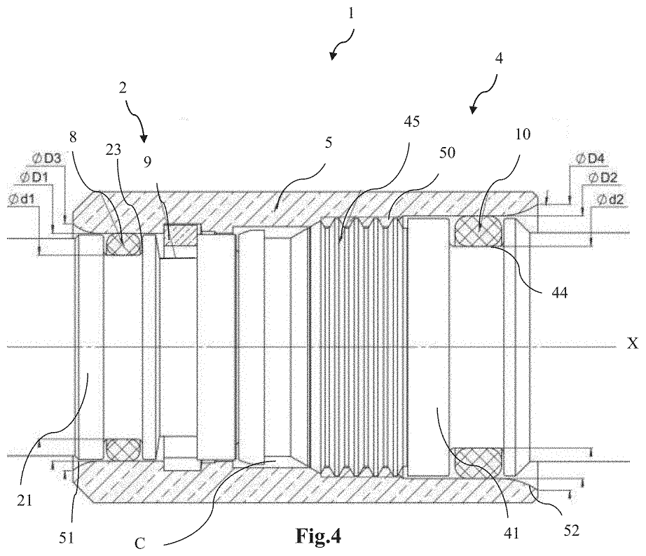

The mutual connection between the plug 2 and the jack 4 is shown on FIG. 4. The bottom diameter d1 of the groove 24 is greater than the inner diameter of the first O-ring seal 8, and the inner diameter D1 of the locking cap 5 is smaller than the outer diameter of the first O-ring seal 8. The ground contact 21 stretches the first O-ring seal 8, to a certain degree while the locking cap 5 on the other hand compresses radially the first O-ring seal 8, a bit so that the liquid outside cannot penetrate through the gap between the ground contact 21 and the locking cap 5.

Likewise, the inner diameter of the second O-ring seal 10 is smaller than the bottom diameter d2 of the groove 44 on the ground contact 41 while its outer diameter is greater than the inner diameter D2 of the locking cap 5, ensuring that the ground contact 41 stretches the second O-ring seal 10 somewhat, while the locking cap 5 imposes a certain amount of compression on the second O-ring seal 10 making the liquid outside not able to penetrate through the gap between the ground contact 41 and the locking cap 5.

In this way, the first O-ring seal 8, the peripheral bodies 21, 41, the locking cap 5 which is screwed and the second O-ring seal 10, form an enclosed space C, or a sealed cavity C, keeping the liquid outside, thus it ensures the IP68 rating.

Instead of being accommodated in the groove 44, the second sealing member 10 could be lodged in the internal surface of the locking nut 5 in an internal groove for example, without departing from the framework of the invention.

Besides, by guaranteeing an external surface of the locking cap 5 which is protected against the galvanic corrosion, the durability of this sealing solution with the enclosed space C is ensured, even in outdoor environments with extreme conditions.

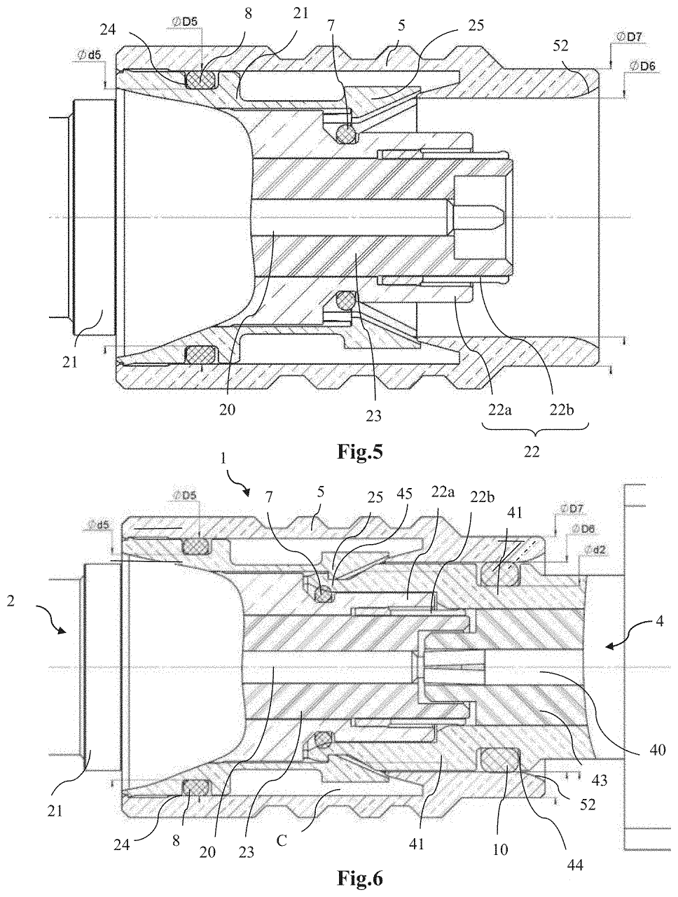

A second embodiment of a coaxial connection system is shown on FIGS. 5 and 6. Here the locking between the plug 2 and the jack 4 is ensured by a cap 5, of a quick lock type which is clipped.

More precisely, the locking between the plug 2 and the jack 4 is ensured by clipping means 25, 45 arranged inside the locking cap 5. Thus, the clipping means 25 are clipped directly onto the external surface of the free end 45 of the ground contact 41 of the jack 4.

The first elastic O-ring seal 8 is fitted in the groove 24 between the third housing ground contact 21 and the locking cap 5. The outer diameter of the first elastic O-ring seal 8 is larger than the inner diameter D5 of the locking cap 5, and the inner diameter of the first elastic O-ring seal 8 is smaller than the bottom diameter d5 of the groove such that the first elastic O-ring seal 8 fills the gap between the peripheral body 21 and the connecting cap 5.

The chamfer 52 which has a diameter D7 is larger than the outer diameter d4 of the second elastic O-ring seal 10 to ensure that this latter will not be damaged while coupling the plug 2 and the socket 4 and the locking by clipping the cap 5.

The mutual connection between the plug 2 and the socket 4 is shown on FIG. 6. The plug 2 contains the first elastic O-ring seal 8 inside, which is located in the groove 21. The bottom diameter d5 of the groove 24 is greater than the inner diameter of the elastic O-ring seal 8 and the inner diameter D5 of the locking cap 5 is smaller than the outer diameter of the elastic O-ring seal 10. The peripheral body 21 stretches the first elastic O-ring seal 8 to a certain degree while the locking cap 5 on the other hand compresses the elastic O-ring seal 8 a bit so that the liquid outside cannot penetrate through the gap between the peripheral body 21 and the locking cap 5.

Likewise, the jack 4 contains the second elastic O-ring seal 10 between the ground contact body 41 and the locking cap 5. The inner diameter of the second elastic O-ring seal 10 is smaller than the bottom diameter d2 of the groove 44 while its outer diameter is greater than the inner diameter D6 of the locking cap 5, ensuring that the ground contact body 41 stretches the second elastic O-ring seal 10 somewhat while the locking cap 5 imposes a certain amount of compression on the second elastic O-ring seal 10, making the liquid outside not able to penetrate through the gap between the ground contact body 41 and the locking cap 5.

In this way, the first O-ring seal 8, the peripheral bodies 21, 41, the locking cap 5 which is clipped and the second O-ring seal 10 form an enclosed space C, or a sealed cavity C, keeping the liquid outside the locking system, thus it ensures the IP68 rating.

Besides, by guaranteeing an external surface of the locking cap 5 which is protected against the galvanic corrosion, the durability of this sealing solution with the enclosed space C is ensured, even in outdoor environments with extreme conditions.

Other variants and enhancements can be provided without in any way departing from the framework of the invention.

Thus, in all the shown embodiments, the annular sealing members are under the form of O-ring seals. But, lip seals or multi-lips seals are also possible. Also, molded gaskets under the locking/unlocking cap are possible . . . .

The expression “comprising a” should be understood to be synonymous with “comprising at least one”, unless otherwise specified.

1. A coaxial connection system, intended to be used in an outdoor environment, comprising:
a first system element forming a plug and a second system element forming a socket, the plug and the socket each comprising:
a central contact,
a peripheral body, arranged on the periphery of the central contact,
a locking cap or nut, mounted free at least in translation around the plug or the jack, between an unlocking position, in which the plug and jack are not locked and a locking position, in which it mechanically locks the plug and the jack in their mutual connecting configuration;
two annular sealing members of elastomeric material resistant to corrosion, one being arranged around the peripheral body of the plug and the other around the peripheral body of the jack, each being distant from the connection interface between the plug and the jack;
wherein said locking cap/nut is at least on its external surface in a corrosion-resistant material; and
wherein the arrangement of said locking cap/nut and of said two annular sealing members is such that the locking cap/nut achieves in its locking position a radial compression to the inside the two annular sealing members defining with them a waterproof cavity.

2. The coaxial connection system according to claim 1, wherein the sealing members are elastic O-ring seals.

3. The coaxial connection system according to claim 1, wherein each sealing member is arranged in a groove of the periphery of the peripheral body.

4. The coaxial connection system according to claim 3, wherein the inner diameter of each of the sealing members is smaller than the bottom diameter of the groove while its outer diameter is greater than the inner diameter of the locking cap.

5. The coaxial connection system according to claim 1, wherein the locking cap ensures the locking by an internal portion being screwed onto a peripheral portion of the peripheral of the jack.

6. The coaxial connection system according to claim 1, wherein the locking cap ensures the locking by clipping means clipped onto the peripheral body of the jack.

7. The coaxial connection system according to claim 1, wherein the locking cap has a peripheral chamfer at least at one of its free ends which diameter is larger than the outer diameter of the annular sealing members.

8. The coaxial connection system according to claim 1, wherein the locking cap is made of a very low or null electrical conductivity material or is coated with a coated with galvanic anti-corrosion coating.

9. The coaxial connection system according to claim 8, wherein the locking cap is made in an amorphous metal.
